(19) United States
(12) Patent Application Publication
(10) Pub. No.: US 2023/0142532 A1
(43) Pub. Date: May 11, 2023

(54) METHOD AND DEVICE FOR SUPPORTING EFFICIENT NETWORK SLICING IN WIRELESS COMMUNICATION SYSTEM

(71) Applicant: Samsung Electronics Co., Ltd., Gyeonggi-do (KR)

(72) Inventors: Dongeun SUH, Gyeonggi-do (KR); Hoyeon LEE, Gyeonggi-do (KR)

(21) Appl. No.: 17/981,812

(22) Filed: Nov. 7, 2022

(30) Foreign Application Priority Data
Nov. 8, 2021 (KR) 10-2021-0152385
Nov. 18, 2021 (KR) 10-2021-0159731

(51) Int. Cl. H04W 60/00; H04W 8/24; H04W 48/18; H04W 48/16

(52) U.S. Cl. CPC H04W 60/00; H04W 8/24; H04W 48/18; H04W 48/16

(57) ABSTRACT

The disclosure relates to a 5G or 6G communication system for supporting a higher data transmission rate. Disclosed is a scheme for efficiently supporting a network slice group in a wireless communication system according to an embodiment of the disclosure.

### CROSS-REFERENCE TO RELATED APPLICATION(S)

This application is based on and claims priority under 35 U.S.C. § 119(a) to Korean Patent Application No. 10-2021-0152385, filed on Nov. 8, 2021, in the Korean Intellectual Property Office, and a Korean Patent Application No. 10-2021-0159731, filed on Nov. 18, 2021, in the Korean Intellectual Property Office, the disclosures of which are incorporated by reference herein in their entirety.

### BACKGROUND

### 1. Field

The disclosure relates generally cell selection in a wireless communication system, and more particularly, to a method and a device for supporting a network slice group in a wireless communication system.

### 2. Description of Related Art

Fifth generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement sixth generation (6G) mobile communication technologies (referred to as beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

Upon developing 5G mobile communication technologies, in order to support services and to satisfy performance requirements in connection with enhanced mobile broadband (eMBB), ultra-reliable low latency communications (URLLC), and massive machine-type communications (mMTC), there has been ongoing standardization regarding beamforming and massive multiple input-multiple output (MIMO) for mitigating radio-wave path loss and increasing radio-wave transmission distances in mmWave, supporting numerologies (e.g., operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio-unlicensed (NR-U) aimed at system operations conforming to various regulation-related requirements in unlicensed bands, NR UE power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial Internet of things (IIoT) for supporting new services through interworking and convergence with other industries, integrated access and backhaul (TAB) for providing a node for network service area expansion by supporting a wireless backhaul link and an access link in an integrated manner, mobility enhancement including conditional handover and dual active protocol stack (DAPS) handover, and two-step random access for simplifying random access procedures (e.g., 2-step random access channel (RACH) for new radio (NR)). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as full dimensional-MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI (from the design stage and internalizing end-to-end AI support functions, and next-generation distributed computing technology for implementing services at levels of complexity exceeding the limit of UE operation capability by utilizing ultra-high-performance communication and computing resources.

### SUMMARY

A network slice priority technique enables a terminal to select a cell that provides a desired slice via cell reselection. Slice information necessary for the technique is provided to the terminal via broadcast or radio resource control (RRC) signaling of a base station (e.g., a radio access network (RAN)), and the slice information is required to at least include identifier values (e.g., single network slice selection assistance information (S-NSSAI)) for all slices provided by the RAN. Therefore, it is necessary to use a radio resource more efficiently.

To this end, an embodiment of the disclosure provides a method capable of using a slice group identifier value representing one or more slice identifiers instead of a slice identifier value.

In addition, an embodiment of the disclosure provides a method for efficiently providing a network slice group in an existing 5G system.

The technical subjects pursued in the disclosure may not be limited to the above-mentioned technical subjects, and other technical subjects which are not mentioned may be clearly understood, through the following descriptions, by those skilled in the art to which the disclosure pertains.

In accordance with an aspect of the disclosure, a method performed by an access and mobility management function (AMF) in a communication system is provided. The method comprises: receiving, from a terminal, a registration request message comprising information indicating that the terminal supports network slice grouping; and transmitting, to the terminal, a registration accept message comprising information on an association of at least one network slice group and at least one network slice included in each of the at least one network slice group, valid in one or more tracking areas (TAs).

In one embodiment, the registration accept message further comprises information on the one or more TAs.

In one embodiment, the method further comprises: receiving, from a network slice selection function (NSSF), the information on the association of the at least one network slice group and the at least one network slice included in each of the at least one network slice group.

In one embodiment, the registration accept message further comprises priority information for the at least one network slice group.

In accordance with an aspect of the disclosure, a method performed by a terminal in a wireless communication system is provided. The method comprises: transmitting, to an access and mobility management function (AMF), a registration request message comprising information indicating that the terminal supports network slice grouping; and receiving, from the AMF, a registration accept message comprising information on an association of at least one network slice group and at least one network slice included in each of the at least one network slice group, valid in one or more tracking areas (TAs).

In one embodiment, the registration accept message further comprises information on the one or more TAs.

In one embodiment, the information on the association of the at least one network slice group and the at least one network slice included in each of the at least one network slice group is received from a network slice selection function (NSSF).

In one embodiment, the registration accept message further comprises priority information for the at least one network slice group, and the priority information is used for a cell reselection.

In accordance with an aspect of the disclosure, an AMF in a communication system is provided. The AMF comprises: a transceiver; and a controller coupled with the transceiver and configured to: receive, from a terminal, a registration request message comprising information indicating that the terminal supports network slice grouping, and transmit, to the terminal, a registration accept message comprising information on an association of at least one network slice group and at least one network slice included in each of the at least one network slice group, valid in one or more tracking areas (TAs).

In accordance with an aspect of the disclosure, a terminal in a wireless communication system is provided. The terminal includes a transceiver and a controller coupled with the transceiver. The controller is configured to transmit, to an access and mobility management function (AMF), a registration request message comprising information indicating that the terminal supports network slice grouping, and receive, from the AMF, a registration accept message comprising information on an association of at least one network slice group and at least one network slice included in each of the at least one network slice group, valid in one or more tracking areas (TAs).

According to an embodiment of the disclosure, a network service provider may more flexibly provide a slice group identifier via a method for providing a network slice group identifier in a 3GPP 5G system.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a method for acquiring network slice group information (NSGI) by a base station in a new generation (NG) setup request procedure, according to an embodiment;

FIG. 2 is a diagram illustrating a method for acquiring NSGI by a base station in a RAN configuration update procedure, according to an embodiment;

FIG. 3 is a diagram illustrating a method for providing NSGI information (a list of TA list and NSGI) for each TA with respect to a user equipment (UE) in a UE registration procedure according to an embodiment;

FIG. 4 is a diagram illustrating a method for providing NSGI information for each TA with respect to a user equipment (UE) in a UE configuration update procedure, according to an embodiment;

FIG. 5 is a diagram illustrating a procedure in which a UE performs cell reselection when a base station provides slice group information supported by the base station itself via broadcast, according to an embodiment;

FIG. 6 is a diagram illustrating a procedure in which a UE performs cell reselection when a base station provides slice group information supported by the base station itself to the UE via RRC signaling, according to an embodiment;

FIG. 7 is a diagram illustrating a procedure in which a UE performs cell reselection when a base station provides slice group information supported by the base station itself to the UE via RRC signaling or a broadcast message, according to an embodiment;

FIG. 8 is a diagram illustrating a configuration of a UE, according to an embodiment; and

FIG. 9 is a diagram illustrating a configuration of a network entity, according to an embodiment.

### DETAILED DESCRIPTION

Embodiments of the disclosure are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the disclosure. The terms described below are defined in consideration of the functions in the disclosure, and may be different according to users, intentions of the users, or customs. Therefore, the definitions of the terms should be made based on the contents throughout the specification.

Herein, terms for identifying access nodes, terms for identifying access nodes, terms referring to network entities, terms referring to messages, terms referring to interfaces between network entities, terms referring to various identification information, and the like are illustratively used for the sake of convenience. Therefore, the disclosure is not limited by the terms as used below, and other terms referring to subjects having equivalent technical meanings may be used.

A 5G mobile communication network includes a 5G UE (e.g., a terminal), a 5G RAN (e.g., a base station, a 5G nodeB (gNB), an evolved nodeB (eNB), etc.), and a 5G core network. The 5G core network includes network functions such as an AMF of providing a mobility management function of a UE, a session management function (SMF) of providing a session management function, a user plane function (UPF) of performing a data transfer, a policy control function (PCF) of providing a policy control function, a unified data management (UDM) of providing a management function of data such as subscriber data and policy control data, and a unified data repository (UDR) of storing data of various network functions such as the UDM.

In a 5G system, a network slicing technology (network slicing) refers to a technology and a structure that enables virtualized, independent, and logical multiple networks in one physical network. A network service provider provides a service by configuring a virtual end-to-end network referred to as a network slice in order to satisfy the specialized requirements of a service/application. In this case, the network slice is identified by an identifier referred to as S-NSSAI. The network transmits an allowed slice set (e.g., allowed NSSAI(s)) to a UE in a terminal registration procedure (e.g., a UE registration procedure), and the UE transmits or receives application data via a protocol data unit (PDU) session generated through one S-NSSAI (e.g., a network slice) among the allowed slice set.

There is a problem that, when the RAN to which the UE is connected does not support a network slice desired by the UE itself, the UE cannot use the corresponding network slice. In order to solve the problem, a network slice priority technique has emerged such that the UE can select the RAN again (e.g., cell reselection). In the network slice priority technique, the UE may select the RAN via slice information (info) and slice priority information. The slice information is information provided by the RAN to the UE via RRC signaling, and includes slice information supported by the RAN and information on frequencies which are prioritized for each slice with respect to corresponding slices. The slice priority information is information acquired by the UE from a non-access stratum (NAS) layer and indicates priority information for each slice to be considered by the UE at the time of reselecting a cell.

The network slice priority technique enables the UE to select a cell that provides a desired slice via cell reselection. Slice information necessary for the technique is provided to the UE via RRC signaling of the RAN, and the slice information is required to at least include identifier values (e.g., S-NSSAI) for all slices provided by the RAN. Therefore, it is necessary to use a radio resource more efficiently. To this end, a method of using a slice group identifier value representing one or more slice identifiers instead of a slice identifier value may be considered.

An embodiment provides a scheme for providing a network slice group in a wireless communication system.

According to an embodiment, a method is provided for proposing a network slice group management function (NSGMF) that stores information on a network slice group and provides related services, and for providing the information on the slice group to a UE (e.g., a terminal) and a RAN (e.g., a base station) via the NSGMF.

The NSGMF may be a network entity separate from a network entity such as the AMF, the SMF, or the PCF. Alternatively, the NSGMF may be a function included in the AMF. Alternatively, the NSGMF may be a function included in a network slice selection function (NSSF). The NSSF is a network entity that selects an optimal network slice that can be serviced for a service requested by the UE, and provides optimal AMF or AMF set information that can support the requested service allowed to a user in the network. Alternatively, the NSGMF may be a function included in a network slice admission control (NSAC) function (NSACF). The NSACF is a network entity that performs a NSAC function, and the NSACF prevents the number of registered UEs for each network slice and the number of established PDU sessions for each network (e.g., number of registered UEs per network slice and number of established PDU sessions per network slice, respectively) from exceeding defined maximum values, respectively. Alternatively, the NSGMF may be a function included in another network entity such as the SMF or the PCF.

In addition, the NSGMF may more flexibly provide a slice group by enabling a different network slice grouping scheme (NSGS) (e.g., a network slice grouping method) to be used for a TA or multiple TAs.

In addition, when network slice group information (NSGI) (e.g., mapping information between network slice identifier(s) and network slice group identifier(s)) is provided to the RAN, only necessary mapping information may be included in the NSGI in consideration of TA information provided by the RAN so as to minimize overhead.

In addition, when a TA list for each UE, which is determined in advance to determine NSGI information for each TA provided to a UE, is determined, a suitable TA list and NSGI information for each TA may be determined in consideration of TA movement record information of the UE or the like.

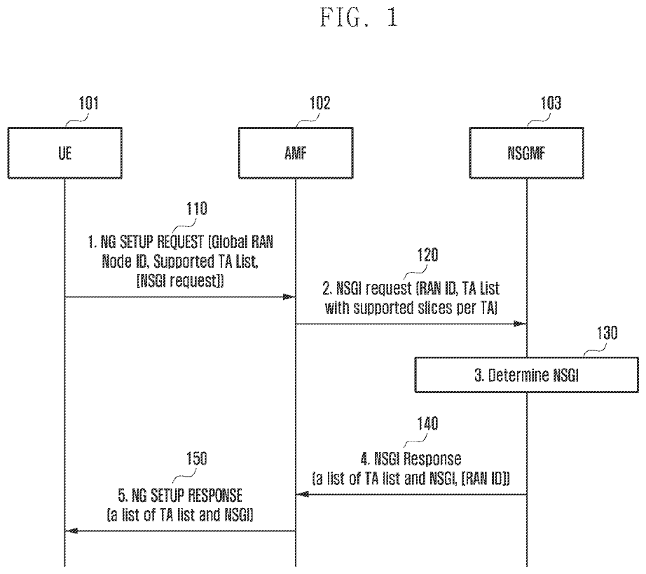

FIG. 1 is a diagram illustrating a method for acquiring NSGI by a base station in an NG setup request procedure, according to an embodiment.

An NG setup request procedure refers to a procedure performed to update application level configuration data between a base station (e.g., RAN) 101 and an AMF 102.

When the RAN 101 supports a network slice grouping, in the procedure, the RAN 101 may receive NSGI.

The NSGI indicates information including slice group identifiers and slice identifiers for each group.

Referring to FIG. 1, at 110, the RAN 101 may transmit an NG setup request message to the AMF 102.

The NG setup request message may include at least one of the following information:

A global RAN Node identity (ID), a supported TA list, etc.

The supported TA list may include information on TAs supported by the RAN 101.

That is, a tracking area code (TAC) indicating an identifier for a TA for each TA and public land mobile network (PLMN) list information broadcasted in a corresponding TA may be included.

The PLMN list information may include a PLMN ID indicating a PLMN identifier, a corresponding PLMN, and a tracking area identity (TAI) slice support list, which is slice information supported by the corresponding TA.

When the RAN 101 requires the NSGI, the RAN 101 may include NSGI request information in the NG setup request message. The NSGI request information is information indicating that the NSGI is required, and the NSGI request information may be in the form of an identifier.

In addition, even when the RAN 101 supports a network slice grouping function (e.g., a function of transmitting information on slices supported by the RAN 101 as a slice group value including multiple slices to efficiently use a radio resource at the time of transmitting the information via a radio channel) and a network slice priority function (e.g., a function in which the RAN 101 provides information on slices (or slice groups) supported by the RAN itself to a UE to enable cell selection and cell reselection of the UE), the NG setup request message may include an NSGI request. Alternatively, when the RAN 101 supports the network slice grouping function and the network slice priority function, the NG setup request message may not include the NSGI request. Even in this case, the AMF 102 may consider that the RAN 101 has requested the NSGI, and may perform the operations after operation 120 of FIG. 1.

At 120, the AMF 102 may transmit a message for requesting the NSGI to an NSGMF 103 in the cases enumerated below. The request message may be an NSGI request message.

The above-described cases includes a case where the AMF 102 receives the NSGI request information from the RAN 101, a case where the RAN 101 supports the network slice grouping function, and a case where the AMF 102 supports the network slice grouping function.

The message for requesting the NSGI (e.g., a message transmitted by the AMF to the NSGMF) may include at least one of the following information.

The above-described information includes a RAN ID (e.g., a RAN identifier), a TA list including information on a TA and slices supported for each TA as an element, etc.

At 130, when the NSGMF 103 receives a message from the AMF 102, the NSGMF 103 may determine an NSGS, which is a scheme of allocating slice identifiers as slice group identifiers for each TA with respect to TAs supported by the RAN 101.

In addition, the NSGMF 103 may determine slice group identifier mapping information (e.g., NSGI for corresponding slices) with respect to slices supported for each TA supported by the corresponding RAN 101 via the determined NSGS method.

At least one of the following pieces of information may be considered in determining the NSGS:

A RAN ID, TAs supported by the RAN 101, slice information supported by the TAs supported by the RAN 101, slice set history information requested by the UE during network registration, etc.

When NSGS information on the corresponding TA already exists (e.g., when an NSGS and NSGI for the corresponding TA are determined by another AMF), the NSGMF 103 may use the corresponding NSGI.

After determining the NSGS and NSGI, the NSGMF 103 may store at least one of the following pieces of information:

A RAN ID, an NSGS, TA information supported by the RAN 101, slice information supported for each TA, NSGI for each TA, etc.

At 140, the NSGMF 103 may receive the message of 120, and transmit the following information through a message transmitted to the AMF 102 after operation 130:

The above-described information transmitted through the message may include NSGI information (e.g., a list of TA list and NSGI) determined for each TA with respect to all TAs supported by the RAN 101 in operation 130, a RAN ID, etc. When the same NSGI is allocated to all TAs supported by the RAN 101, TA list information (for example, TA identifier list information) may be omitted.

In this case, the message through which the information is transmitted may be an NSGI response message.

At 150, the AMF 102 may transmit an NG setup response message to the RAN 101 as a response message with respect to operation 110.

In this case, the corresponding message may include the NSGI information.

The RAN 101 may use a slice group identifier instead of a slice identifier for the UE in the information transmitted to the UE by using the NSGI.

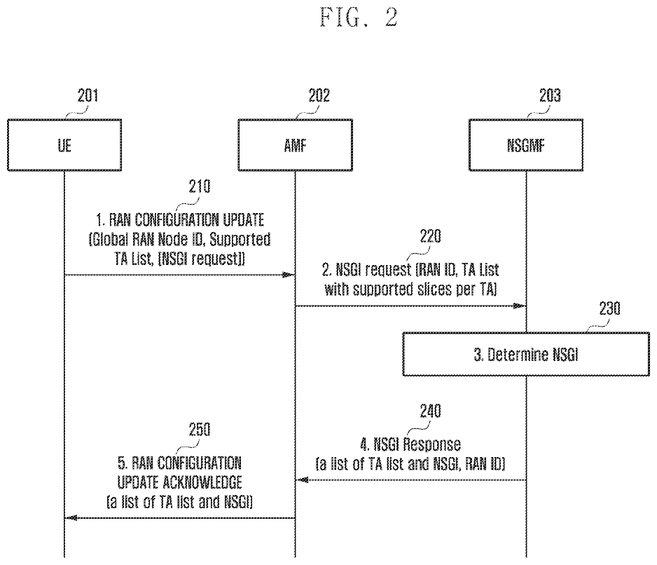

FIG. 2 is a diagram illustrating a method for acquiring NSGI by a base station in a RAN configuration update procedure, according to an embodiment.

The RAN configuration update procedure refers to a procedure performed to update application level configuration data between a base station (e.g., RAN) 201 and an AMF 202.

When the RAN 201 supports a network slice grouping, in the procedure, the RAN 201 may receive NSGI.

The NSGI indicates information including slice group identifiers and slice identifiers for each group.

Referring to FIG. 2, at 210, the RAN 201 may transmit a RAN configuration update message to the AMF 202.

The RAN configuration update message may include at least one of the following pieces of information:

A global RAN Node ID, a supported TA list, etc.

The supported TA list may include information on TAs supported by the RAN 201.

That is, a TAC indicating an identifier with respect to a TA for each TA and PLMN list information broadcasted from the corresponding TA may be included.

The PLMN list information may include a PLMN identity indicating a PLMN identifier, a corresponding PLMN, and a TAI slice support list which is slice information supported by the corresponding TA.

When the RAN 201 determines that NSGI is required or an NSGI update is required (e.g., a change of a TA list supported by the RAN 201 or a change of slice support information for each TA, etc.), the RAN 201 may include an NSGI request in the RAN configuration update message. NSGI request information is information indicating that the NSGI is required, and the NSGI request information may be in the form of an identifier.

In addition, even when the RAN 201 supports a network slice grouping function (e.g., a function of transmitting information on slices supported by the RAN 201 as a slice group value including multiple slices to efficiently use a radio resource at the time of transmitting the information via a radio channel) and a network slice priority function (e.g., a function in which the RAN 201 provides information on slices (or slice groups) supported by the RAN itself to a UE to enable cell selection and cell reselection of the UE), the RAN configuration update message may include the NSGI request.

Alternatively, when the RAN 201 supports the network slice grouping function and the network slice priority function, the RAN configuration update message may not include the NSGI request. Even in this case, the AMF 202 may consider that the RAN 201 has requested the NSGI, and may perform the operations after 220 of FIG. 2.

At 220, the AMF 202 may transmit a message for requesting the NSGI to a NSGMF 203 in the cases enumerated below. The request message may be an NSGI request message.

The above-described cases includes a case where the AMF 202 receives the NSGI request information from the RAN 201, a case where the RAN 201 supports the network slice grouping function, and a case where the AMF 202 supports the network slice grouping function.

The message for requesting the NSGI (e.g., a message transmitted by the AMF 202 to the NSGMF 203) may include at least one of the following pieces of information.

The above-described information includes a RAN ID, a TA list including information on a TA and slices supported for each TA as an element, etc.

At 230, when the NSGMF 203 receives a message from the AMF 202, the NSGMF 203 may determine an NSGS, which is a scheme of allocating slice identifiers as slice group identifiers for each TA with respect to TAs supported by the RAN 201.

In addition, the NSGMF 203 may determine slice group identifier mapping information (e.g., NSGI for corresponding slices) with respect to slices supported by a TA supported by the corresponding RAN 201 via the determined method.

At least one of the following pieces of information may be considered in determining the NSGS:

A RAN ID, TAs supported by the RAN, slice information supported by TAs supported by the RAN 201, slice set history information requested by the UE during network registration, etc.

When NSGS information on the corresponding TA already exists (e.g., when an NSGS and NSGI for the corresponding TA are determined by another AMF), the NSGMF 203 may use the corresponding NSGI.

After determining the NSGS and NSGI, the NSGMF 203 may store at least one of the following pieces of information:

A RAN ID, an NSGS, TA information supported by the RAN, slice information supported for each TA, NSGI for each TA, etc.

At 240, the NSGMF 201 may receive the message of 220, and transmit the following information through a message transmitted to the AMF 202 after 230:

The above-described information transmitted through the message may include NSGI information (e.g., a list of TA list and NSGI) determined for each TA with respect to all TAs supported by the RAN 201 in 230, a RAN ID, etc. When the same NSGI is allocated to all TAs supported by the RAN 201, TA list information (e.g., TA identifier list information) may be omitted.

In this case, the message through which the information is transmitted may be an NSGI response message.

At 250, the AMF 202 transmits a RAN configuration update acknowledge message to the RAN 201 as a response message with respect to operation 210.

In this case, the corresponding message may include the NSGI information.

The RAN 201 may use a slice group identifier instead of a slice identifier for the UE in the information transmitted to the UE by using the NSGI.

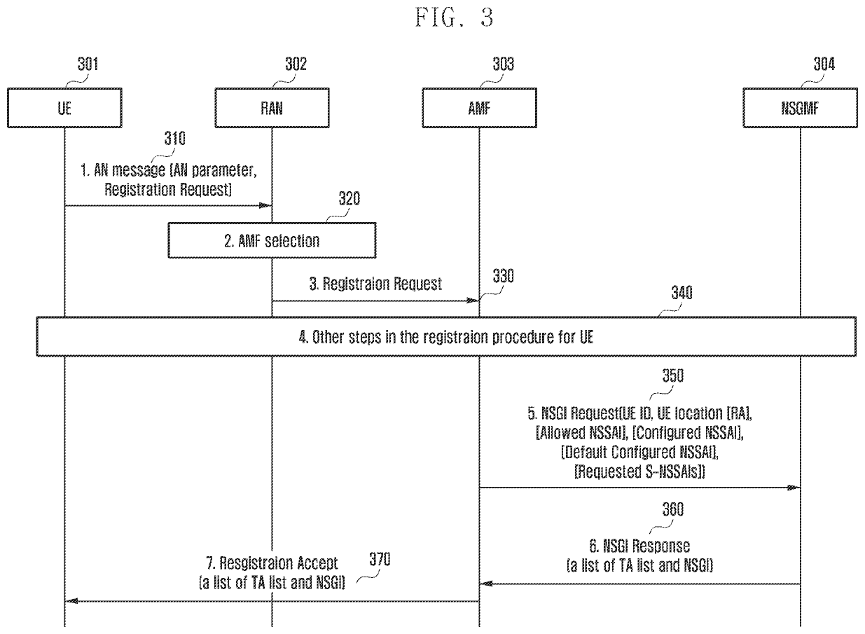

FIG. 3 is a diagram illustrating a method for providing NSGI information (a list of TA list and NSGI) for each TA with respect to a UE in a UE registration procedure, according to an embodiment.

Referring to FIG. 3, at 310, a UE 301 may transmit an access network (AN) message (e.g., an AN parameter and a registration request) to a base station (e.g., RAN) 302. In this case, a registration request message may include at least one of a UE identifier (e.g., a subscription concealed identifier (SUCI), 5G-globally unique temporary identity (5G-GUTI), or a permanent equipment identifier (PEI)), requested NSSAI, UE mobility management (MM) core network capability, and the like.

The registration request message may include whether the UE supports a slice grouping.

The registration request message may include information related to whether the UE 301 supports a network slice priority (NSP). In this case, whether a network slice grouping is supported and whether a network slice priority is supported may be provided as one indicator.

At 320, the RAN 302 may select an AMF 303, based on information in the AN message received from the UE 301.

At 330, the RAN 302 may transmit an N2 message (e.g., N2 parameters and a registration request) to the AMF 303. An N2 parameter may include a selected PLMN ID, UE location information, a UE context request, and the like.

In this case, the N2 message may include a RAN ID.

At 340, necessary operations in the UE registration procedure may be performed.

At 350, the AMF 303 may transmit a message for requesting a list of TA list and NSGI of the UE 301 to an NSGMF 304 when at least one of the following situations is satisfied:

The above-described situations includes a case where the UE 301 supports a network slice grouping, and a case where the AMF 303 supports a network slice grouping.

The message transmitted by the AMF 303 to the NSGMF 304 may be an NSGI request message.

The AMF 303 may include at least one of the following pieces of information in the message transmitted to the NSGMF 304:

An indicator for requesting a list of TA list and NSGI of the UE 301, a UE ID, a UE location (e.g., a TA), a slice set (e.g., allowed NSSAI) allowed to the UE 301, a slice set (e.g., configured NSSAI and default configured NSSAI) configured to the UE 301, a slice set (e.g., requested S-NSSAIs) requested by the UE 301, etc.

The AMF 303 may transmit a message for requesting NSP information (e.g., information including priority information for each slice with respect to slice(s)) of the UE 301 to the NSGMF 304 when at least one of the following situations is satisfied:

The above-described situations include a case where the UE 301 supports a network slice priority function, and a case where the AMF 303 supports a network slice priority.

The message transmitted by the AMF 303 to the NSGMF 304 may be an NSP request message.

The AMF 303 may include at least one of the following pieces of information in the message transmitted to the NSGMF 304:

An indicator for requesting NSP information, a UE ID, UE location information (e.g., a TA), information (e.g., allowed NSSAI) related to a slice set allowed to the UE 301, information (e.g., configured NSSAI and default configured NSSAI) related to a slice set configured to the UE 301, information related to a slice set requested by the UE 301 (e.g., requested S-NSSAIs), etc.

At 360, when the received message includes the UE ID or the indicator for requesting the list of TA list and NSGI for the UE 301, the NSGMF 304 may calculate/determine/identify the list of TA list and NSGI and then transmit the same to the AMF 303.

The list of TA list and NSGI may be included in an NSGI response message and transmitted from the NSGMF 304 to the AMF 303.

The list of TA list and NSGI may include the following information:

TA information (e.g., a TA list) and a valid NSGI in the corresponding TA list.

At the time of identifying the list of TA list and NSGI, first, the NSGMF 304 identifies TA lists which should be provided NSGI to the UE 301, and finds NSGI information corresponding to a TA or TAs in the TA list based on information stored in the NSGMF 304.

The NSGMF 304 may consider at least one of the following pieces of information at the time of identifying the TA lists which should be provided NSGI to the UE 301:

TA movement record information of the UE 301, the information received in 350, an NSGS for each RAN ID stored in the NSGMF 304, a supported TA list, supported slices, NSGI information, etc.

In addition, when the received message includes the UE ID or the indicator for requesting the NSP information for the UE 301, the NSGMF 304 may identify the NSP information and then transmit the same to the AMF.

The NSP information may be included in the NSGI response message and transmitted from the NSGMF 304 to the AMF 303.

The NSP information may include at least one of the following pieces of information:

priority information for each of the slice(s), or priority information of each of slice(s) with respect to each of TA(s) for the TA(s), etc.

When slices targeted by the NSP information are configured, at least one of the following information may be considered:

Information on slices provided in a TA set in consideration of a location of the UE 301, an RA of the UE 301, or a TA list for each NSGI, slice set information (e.g., subscribed S-NSSAIs) included in subscriber information of the UE 301, configured slice set information (e.g., configured NSSAI) of the UE 301, etc.

At 370, the AMF 303 may include a registration accept message in the N2 message and transmit the registration accept message to the RAN 302. When the AMF 303 receives the list of TA list and NSGI in 360, the AMF 303 may include the list of TA list and NSGI received in 360 in the registration accept message.

The RAN 302 may transmit the registration accept message in the N2 message received from the AMF 303 to the UE 301.

When the UE 301 receives the list of TA list and NSGI, the UE 301 is aware of slice group identifiers to be used for each slice identifier according to a location (e.g., a TA) (e.g., NSGI to be used according to a TA) at the time of reselecting a cell.

The AMF 303 may include the registration accept message in the N2 message and transmit the registration accept message to the RAN 302. In this case, when the AMF 303 receives the NSP information in 360, the AMF 303 may include the NSP information received in 360 in the registration accept message.

The RAN 302 may transmit the registration accept message in the N2 message received from the AMF 303 to the UE 301.

When the UE 301 receives the NSP information, the UE 301 may select a cell, based on the NSP information, at the time of performing a cell reselection procedure or performing an initial access procedure (e.g., a RACH procedure).

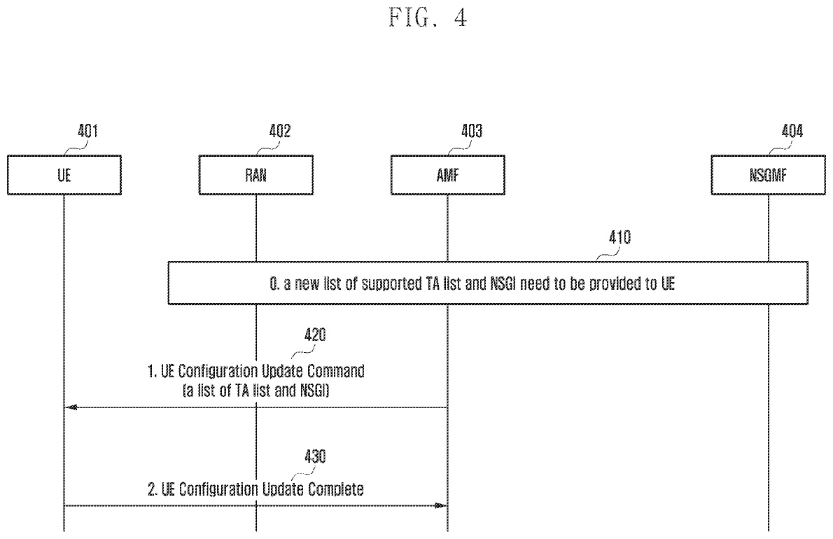

FIG. 4 is a diagram illustrating a method for providing NSGI information (a list of supported TA list and NSGI) for each TA with respect to a UE in a UE configuration update procedure (e.g., a UE configuration update procedure), according to an embodiment.

Referring to FIG. 4, at 410, when it is necessary to change a list of TA list and NSGI for a UE 401, an NSGMF 404 may newly calculate/determine/identify a list of TA list and NSGI for the UE 401 and transmit the list of TA list and NSGI to the AMF 403. In addition, at 410, when it is necessary to change NSP information for the UE 401, the NSGMF 404 may newly identify the NSP information for the UE 401 and transmit the NSP information to the AMF 403.

At 420, the AMF 403 may include the list of TA list and NSGI for the UE 401 in a UE configuration update command message in order to transmit the changed list of TA list and NSGI for the UE 401 to the UE 401, and transmit the UE configuration update command message to the UE 401 (via a base station 402). A UE configuration update command may include an indicator indicating that the UE 401 has received the corresponding message.

At 420, the AMF 403 may include the NSP information for the UE 401 in the UE configuration update command message in order to transmit the changed NSP information for the UE 401 to the UE 401, and transmit the UE configuration update command message to the UE 401 (via the base station 402). The UE configuration update command may include an indicator indicating that the UE 401 has received the corresponding message.

At 430, the UE 401 may update the existing list of TA list and NSGI to the list of TA list and NSGI received in operation 420. In addition, the UE 401 may update the existing NSP information to the NSP information received in operation 420.

When, in 420, the indicator indicating that the UE 401 has received the corresponding message is included in the transmitted message, or the list of TA list and NSGI is included in the UE configuration update command, the UE 401 may transmit a UE configuration update complete message to the AMF 403 (via the base station 402). In addition, when, in 420, the indicator indicating that the UE 401 has received the corresponding message is included in the transmitted message, or the NSP information is included in the UE configuration update command, the UE 401 may transmit the UE configuration update complete message to the AMF 403 (via the base station 402).

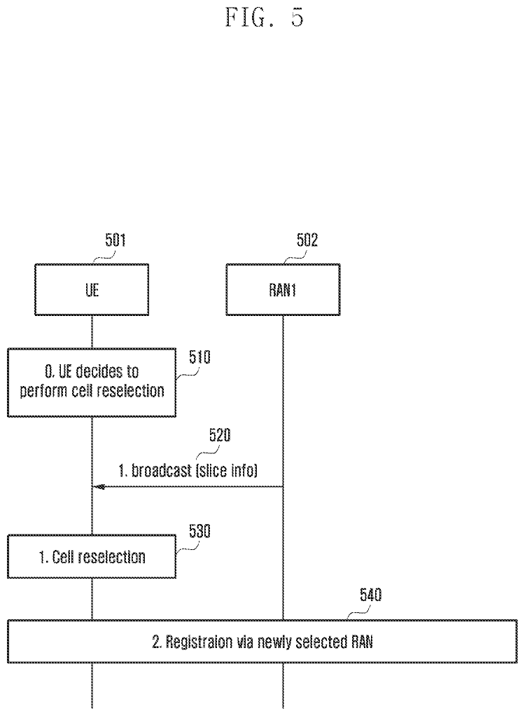

FIG. 5 is a diagram illustrating a procedure in which a UE performs cell reselection when a base station provides slice group information supported by the base station itself via broadcast according to an embodiment.

Referring to FIG. 5, at 510, when a UE 501 supports a slice grouping and has NSGI (e.g., mapping information between slice identifier(s) and a slice group identifier), and the UE 501 identifies that a desired network slice is not supported by the currently serving base station (e.g., RAN), the UE 501 may perform a cell reselection procedure.

At 520, neighboring base stations (e.g., RAN1, etc.) 502 that support the slice grouping and have received the NSGI may include slice information including slice group identifier information supported by the base stations by themselves in a broadcast message according to the received NSGI, and broadcast the broadcast message.

At 530, the UE 501 may compare slice group identifier information mapped to the desired slice with the slice group identifier information included in the received broadcast message, so as to select a RAN1 502 supporting a corresponding slice group.

At 540, the UE 501 may perform a network registration procedure via the newly selected RAN1 502.

In this case, the UE 501 may include desired network slice information in requested NSSAI (e.g., requested slice information) of a network registration request message.

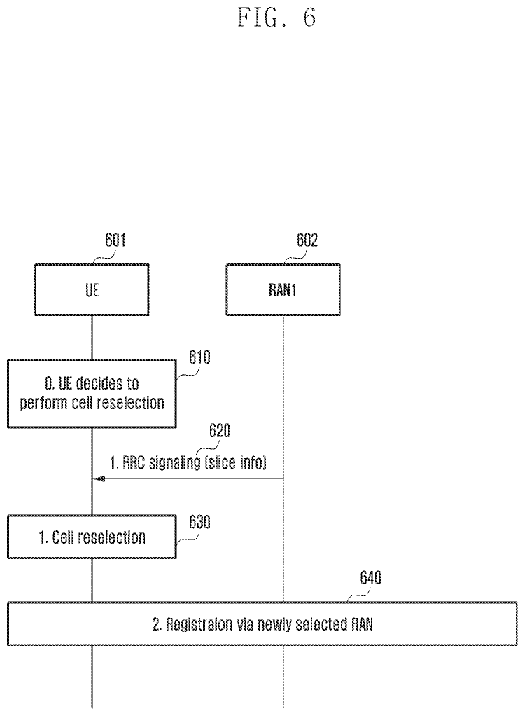

FIG. 6 is a diagram illustrating a procedure in which a UE performs cell reselection when a base station provides slice group information supported by the base station itself to the UE via RRC signaling, according to an embodiment.

Referring to FIG. 6, at 610, when a UE 601 supports a slice grouping and has NSGI (e.g., mapping information between slice identifier(s) and a slice group identifier), and the UE 601 identifies that a desired network slice is not supported by the currently serving base station (e.g., RAN), the UE 601 may perform a cell reselection procedure.

At 620, the RAN1 602, which supports the slice grouping and has received the NSGI, may include slice information including slice group identifier information supported by the RAN1 itself in an RRC signaling message according to the received NSGI, and transmit the RRC signaling message to the UE 601.

At 630, the UE 601 may compare slice group identifier information mapped to the desired slice with the slice group identifier information included in the received RRC signaling message, and when a corresponding slice group is supported, select the corresponding RAN1 602.

At 640, the UE 601 may perform a network registration procedure via the newly selected RAN1 602.

In this case, the UE 601 may include desired network slice information in requested NSSAI (that is, requested slice information) of a network registration request message.

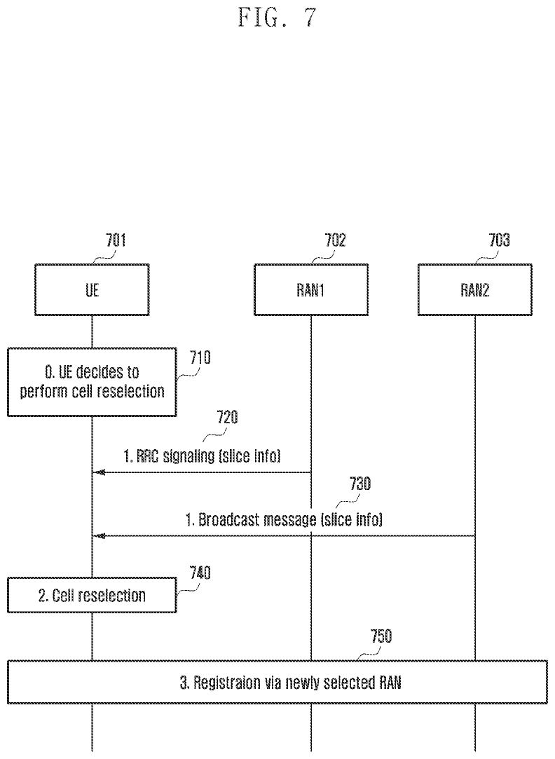

FIG. 7 is a diagram illustrating a procedure in which a UE performs cell reselection when a base station provides slice group information supported by the base station itself via RRC signaling or a broadcast message according to an embodiment.

Referring to FIG. 7, at 710, when a UE 701 supports a slice grouping and has NSGI (e.g., mapping information between slice identifier(s) and a slice group identifier), and the UE 701 identifies that a desired network slice is not supported by the currently serving base station (e.g., RAN), the UE 701 may perform a cell reselection procedure.

At 720, a RAN1 702, which supports the slice grouping and has received the NSGI, may include slice information including slice group identifier information supported by the RAN1 itself in an RRC signaling message according to the received NSGI, and transmit the RRC signaling message to the UE 701. In addition, at 730, a RAN2 703, which supports the slice grouping and has received the NSGI, may include slice information including slice group identifier information supported by the RAN2 by itself in a broadcast message according to the received NSGI, and broadcast the broadcast message.

At 740, the UE 701 may compare slice group identifier information mapped to the desired slice with the slice group identifier information included in the broadcast message and the RRC signaling message, and select a RAN which supports a corresponding slice group.

At 750, the UE 701 may perform a network registration procedure via the newly selected RAN.

In this case, the UE 701 may include desired network slice information in requested NSSAI (e.g., requested slice information) of a network registration request message.

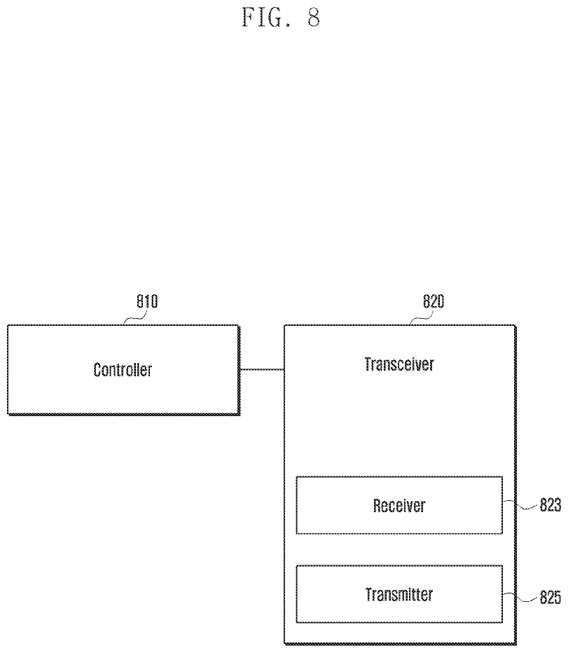

FIG. 8 is a diagram illustrating a configuration of a UE, according to an embodiment.

Referring to FIG. 8, a UE according to an embodiment of the disclosure may include a transceiver 820 and a controller 810 that controls the overall operations of the UE. In addition, the transceiver 820 may include a transmitter 825 and a receiver 823.

The transceiver 820 may transmit or receive a signal to or from other network entities.

The controller 810 may control the UE to perform an operation of one of the above-described embodiments. The controller 810 and the transceiver 820 may not necessarily be implemented as separate modules, and may be implemented as one component in the form of a single chip. In addition, the controller 810 and the transceiver 820 may be electrically connected to each other. For example, the controller 810 may be a circuit, an application-specific circuit, or at least one processor. In addition, the operations of the UE may be implemented by including, in a predetermined component in the UE, a memory device storing a corresponding program code.

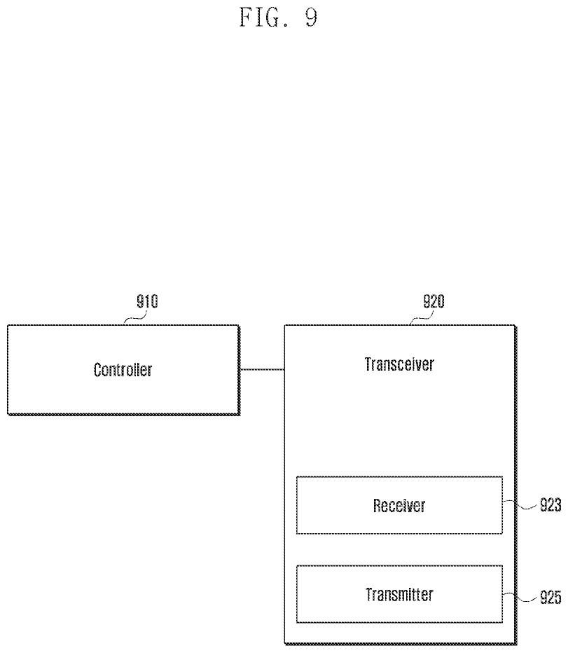

FIG. 9 is a diagram illustrating a configuration of a network entity, according to an embodiment.

A network entity of the disclosure is a concept including a network function according to a system implementation.

Referring to FIG. 9, the network entity may include a transceiver 920 and a controller 910 that controls the overall operations of the network entity. In addition, the transceiver 920 may include a transmitter 925 and a receiver 923.

The transceiver 920 may transmit or receive a signal to or from other network entities.

The controller 910 may control the network entity to perform an operation of one of the above-described embodiments. The controller 910 and the transceiver 920 are not necessarily implemented as separate modules, and may be implemented as one component in the form of a single chip. In addition, the controller 910 and the transceiver 920 may be electrically connected to each other. For example, the controller 910 may be a circuit, an application-specific circuit, or at least one processor. In addition, the operations of the network entity may be implemented by including, in a predetermined component in the network entity, a memory device storing a corresponding program code.

The network entity may be one of a base station (e.g., RAN), an AMF, an SMF, a UPF, a PCF, an NSGMF, an NSSF, an NSACF, a UDM, and a UDR.

It should be noted that the configurations illustrated in FIGS. 1 and 9, the example of the control/data signal transmission method, the example of the operation procedure, and the configurations are not intended to limit the scope of right of the disclosure. In other words, all the components, entities, or operational operations illustrated in FIGS. 1 to 9 should not be construed as essential components for implementing the disclosure, and the disclosure may be implemented within a scope without departing from the gist of the disclosure even when only some of the components are included.

The above-described operations of a base station or a terminal may be implemented by providing a memory device storing corresponding program codes in a base station or terminal device. That is, a controller of the base station or terminal device may perform the above-described operations by reading and executing the program codes stored in the memory device by means of a processor or central processing unit (CPU).

Various units or modules of a network entity, a base station device, or a terminal device may be operated using hardware circuits such as complementary metal oxide semiconductor-based logic circuits, firmware, or hardware circuits such as combinations of software and/or hardware and firmware and/or software embedded in a machine-readable medium. For example, various electrical structures and methods may be implemented using transistors, logic gates, and electrical circuits such as application-specific integrated circuits.

Although specific embodiments have been described in the detailed description of the disclosure, it will be apparent that various modifications and changes may be made thereto without departing from the scope of the disclosure. Therefore, the scope of the disclosure should not be defined as being limited to the embodiments, but should be defined by the appended claims and equivalents thereof.

What is claimed is:

1. A method performed by an access and mobility management function (AMF) in a communication system, the method comprising:
receiving, from a terminal, a registration request message comprising information indicating that the terminal supports network slice grouping; and
transmitting, to the terminal, a registration accept message comprising information on an association of at least one network slice group and at least one network slice included in each of the at least one network slice group, valid in one or more tracking areas (TAs).

2. The method of claim 1,
wherein the registration accept message further comprises information on the one or more TAs.

3. The method of claim 1, further comprising:
receiving, from a network slice selection function (NSSF), the information on the association of the at least one network slice group and the at least one network slice included in each of the at least one network slice group.

4. The method of claim 1, wherein the registration accept message further comprises priority information for the at least one network slice group.

5. A method performed by a terminal in a wireless communication system, the method comprising:
transmitting, to an access and mobility management function (AMF), a registration request message comprising information indicating that the terminal supports network slice grouping; and
receiving, from the AMF, a registration accept message comprising information on an association of at least one network slice group and at least one network slice included in each of the at least one network slice group, valid in one or more tracking areas (TAs).

6. The method of claim 5,
wherein the registration accept message further comprises information on the one or more TAs.

7. The method of claim 5,
wherein the information on the association of the at least one network slice group and the at least one network slice included in each of the at least one network slice group is received from a network slice selection function (NSSF).

8. The method of claim 5, wherein the registration accept message further comprises priority information for the at least one network slice group, and
the priority information is used for a cell reselection.

9. An access and mobility management function (AMF) in a communication system, the AMF comprising:
a transceiver; and
a controller coupled with the transceiver and configured to:
receive, from a terminal, a registration request message comprising information indicating that the terminal supports network slice grouping, and
transmit, to the terminal, a registration accept message comprising information on an association of at least one network slice group and at least one network slice included in each of the at least one network slice group, valid in one or more tracking areas (TAs).

10. The AMF of claim 9, wherein the registration accept message further comprises information on the one or more TAs.

11. The AMF of claim 9, wherein the controller is further configured to:
receive, from a network slice selection function (NSSF), the information on the association of the at least one network slice group and the at least one network slice included in each of the at least one network slice group.

12. The AMF of claim 9, wherein the registration accept message further comprises priority information for the at least one network slice group.

13. A terminal in a wireless communication system, the terminal comprising:
a transceiver; and
a controller coupled with the transceiver and configured to:
transmit, to an access and mobility management function (AMF), a registration request message comprising information indicating that the terminal supports network slice grouping, and
receive, from the AMF, a registration accept message comprising information on an association of at least one network slice group and at least one network slice included in each of the at least one network slice group, valid in one or more tracking areas (TAs).

14. The terminal of claim 13,
wherein the registration accept message further comprises information on the one or more TAs.

15. The terminal of claim 13,
wherein the information on the association of the at least one network slice group and the at least one network slice included in each of the at least one network slice group is received from a network slice selection function (NSSF).

16. The terminal of claim 13, wherein the registration accept message further comprises priority information for the at least one network slice group, and
the priority information is used for a cell reselection.
